(19) United States
(12) Patent Application Publication
(10) Pub. No.: US 2023/0386107 A1
(43) Pub. Date: Nov. 30, 2023

(54) ANTI-ALIASING FOR REAL-TIME RENDERING USING IMPLICIT RENDERING

(71) Applicant: Soul Vision Creations Private Limited, Bengaluru (IN)

(72) Inventors: Sravanth Aluru, Bengaluru (IN); Gaurav Baid, Bengaluru (IN); Shubham Jain, Bengaluru (IN); Nischal Sanil, Bengaluru (IN)

(21) Appl. No.: 18/319,987

(22) Filed: May 18, 2023

Related U.S. Application Data
(60) Provisional application No. 63/365,420, filed on May 27, 2022.

(51) Int. Cl. G06T 11/40; G06N 3/08; G06N 3/04

(52) U.S. Cl. CPC G06T 11/40; G06N 3/04; G06N 3/08

(57) ABSTRACT

A system for graphical rendering includes one or more servers configured to determine a mean vector indicative of a ray through one or more conical frustums and a covariance matrix defining lobes in different directions inside the one or more conical frustums to generate an approximation of the one or more conical frustums, generate an input into a trained neural network based on the determined mean vector and the covariance matrix, wherein the trained neural network is trained based on two-dimensional images at different distances from an object and configured to generate sample values of samples within the object, generate the sample values for rendering from the trained neural network based on the input, and output the sample values.

This application claims the benefit of U.S. Provisional Application No. 63/365,420, filed May 27, 2022, the entire contents of which is incorporated herein by reference.

### TECHNICAL FIELD

The disclosure relates to graphics rendering.

### BACKGROUND

Neural Radiance Field (NeRF) is a machine learning based technique, where a neural network is trained from a sparse set of input views for image content (e.g., a scene). In NeRF, the input to the trained neural network is a position and a direction, and the output of the trained neural network is a color value and density value (e.g., opacity) of the image content for the input position and direction. In this way, processing circuitry may utilize the trained neural network to determine the color values and density values from different positions, and render the image content using the determined color values and density values.

### SUMMARY

In general, the disclosure describes example techniques of real-time rendering of image content that is generated using implicit rendering. Implicit rendering may refer to rendering techniques in which the image content is represented as functions and equations. As one example, implicit rendering may include rendering using machine learning based techniques (e.g., with trained neural networks), such as Neural Radiance Field (NeRF) techniques, as one example.

One example of NeRF is MipNeRF (multum in parvo NeRF). In MipNeRF, the neural network is trained using images of an object from different distances. MipNeRF assists with anti-aliasing by using conical frustums and sampling the trained neural network along the frustums. A conical frustrum may be considered as a cone that is cut along a plane to remove the pointed end, as one example. This disclosure describes example techniques of generating inputs for a trained neural network that is trained based on two-dimensional images at different distances from an object (e.g., such as for MipNeRF) and uses conical frustums for generating samples values of samples of the object. One or more servers may generate sample values for rendering (e.g., volumetric rendering) from the trained neural network based on the input. The one or more servers may output the sample values.

A personal computing device (e.g., mobile device, etc.) may receive the output sample values, and perform rendering, such as volumetric rendering, to reconstruct the object using the sample values. For instance, the sample values may form a texture that a graphics processing unit (GPU) of the personal computing device uses for texture mapping as part of volumetric rendering. In this way, the example techniques allow for real-time rendering (e.g., by the GPU) of image content of an object generated from a trained neural network (e.g., as part of implicit rendering) that provides higher quality image content due to reduced aliasing effects.

In one example, the disclosure describes a system for graphical rendering, the system comprising: one or more servers configured to: determine a mean vector indicative of a ray through one or more conical frustums and a covariance matrix defining lobes in different directions inside the one or more conical frustums to generate an approximation of the one or more conical frustums; generate an input into a trained neural network based on the determined mean vector and the covariance matrix, wherein the trained neural network is trained based on two-dimensional images at different distances from an object and configured to generate sample values of samples of the object; generate the sample values for rendering the object from the trained neural network based on the input; and output the sample values.

In one example, the disclosure describes a method for graphical rendering, the method comprising: determining a mean vector indicative of a ray through one or more conical frustums and a covariance matrix defining lobes in different directions inside the one or more conical frustums to generate an approximation of the one or more conical frustums; generating an input into a trained neural network based on the determined mean vector and the covariance matrix, wherein the trained neural network is trained based on two-dimensional images at different distances from an object and configured to generate sample values of samples of the object; generating the sample values for rendering the object from the trained neural network based on the input; and outputting the sample values.

In one example, the disclosure describes a computer-readable storage medium storing instructions thereon that when executed cause one or more servers to: determine a mean vector indicative of a ray through one or more conical frustums and a covariance matrix defining lobes in different directions inside the one or more conical frustums to generate an approximation of the one or more conical frustums; generate an input into a trained neural network based on the determined mean vector and the covariance matrix, wherein the trained neural network is trained based on two-dimensional images at different distances from an object and configured to generate sample values of samples of the object; generate the sample values for rendering the object from the trained neural network based on the input; and output the sample values.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating a system for real-time rendering of image content of an object generated from implicit rendering.

FIG. 2 is a block diagram illustrating an example of a personal computing device configured to perform real-time rendering of image content generated from implicit rendering in accordance with one or more example techniques described in this disclosure.

FIG. 3 is a flowchart illustrating an example of real-time rendering of image content generated from implicit rendering.

FIG. 4 is a conceptual diagram of illustrating cone being associated with a pixel.

FIG. 5A is a conceptual diagram illustrating conical frustums.

FIG. 5B is a conceptual diagram illustrating lobes inside the frustums.

### DETAILED DESCRIPTION

Content creators for three-dimensional graphical content, such as for extended reality (XR) such as virtual reality (VR), mixed reality (MR), augmented reality (AR), etc. tend to define a three-dimensional object as an interconnection of plurality of polygons. However, generating content in this manner tends to be time, labor, and computationally intensive.

Implicit rendering techniques include a relatively recent manner of creating and rendering three-dimensional graphical content. In implicit rendering, the image content of an object is defined by mathematical functions and equations (e.g., continuous mathematical functions and equations). The continuous mathematical functions and equations are generated from machine learning techniques. For instance, a trained neural network forms the continuous mathematical functions and equations that define the image content of an object. One example technique of implicit rendering is the NeRF technique, and an improvement on NeRF is MipNeRF used for generating image content for different resolutions.

For training the neural network, one or more servers may receive a plurality of two-dimensional images, which tend to be easier to define than a three-dimensional object. The one or more servers train the neural network using the plurality of two-dimensional images as the training dataset for training the neural network. In MipNeRF, the plurality of two-dimensional images may be from different distances from the object, and hence, may be of different resolutions. The one or more servers also use the plurality of two-dimensional images to confirm the validity of the trained neural network.

To render the image content of the object, in some techniques, the one or more servers transmit the trained neural network (e.g., object code of the trained neural network) to a personal computing device (e.g., mobile device like smart phone or tablet, a laptop, a desktop, video gaming console, AR console, etc.). The personal computing device receives the trained neural network and may execute the trained neural network to render the image content of the object. For instance, the personal computing device may input coordinates, and possibly a direction, into the trained neural network, and the output from the trained neural network may be color and density (e.g., opacity) values at the coordinates for the given direction. In some examples of the trained neural network, such as for MipNeRF, the input to the trained neural network may be conical frustums, and the output may the color and density values (e.g., sample values) at a particular coordinate.

The personal computing device may use the color and density values to render the image content of the object. Rendering the image content of the object refers to generating two-dimensional image for display on a screen from the three-dimensional image content of the object.

Implicit rendering techniques tend to produce high-quality image content. However, real-time rendering may be complicated with implicit rendering techniques because executing the trained neural network tends to require relatively high amounts of processing power. Personal computing devices tend to not have such high processing power. Real-time rendering refers to rendering at a rate at which the image content can be displayed in a way that the image content appears smooth as image content is updated. For example, real-time rendering may be rendering at a rate of 30 frames per second or greater.

This disclosure describes example techniques that allow for generation of sample values for rendering an object from a trained neural network, where the trained neural network is trained based on two-dimensional images at different distances from the object. The trained neural network may be generated based on using conical frustums for generating the color and density values (e.g., sample values).

For instance, as described in more detail, one or more servers may be configured to determine a mean vector indicative of a ray through one or more conical frustums and a covariance matrix defining lobes in different directions inside the one or more conical frustums to generate an approximation of the one or more conical frustums, generate an input into a trained neural network based on the determined mean vector and the covariance matrix, wherein the trained neural network is trained based on two-dimensional images at different distances from an object and configured to generate sample values of samples of the object, generate the sample values (e.g., the color and density values) for rendering the object from the trained neural network based on the input, and output the sample values. In some examples, the sample values may be in form of a grid structure (e.g., a two-dimensional grid). A personal computing device may use the two-dimensional grid as a texture, as part of volumetric rendering.

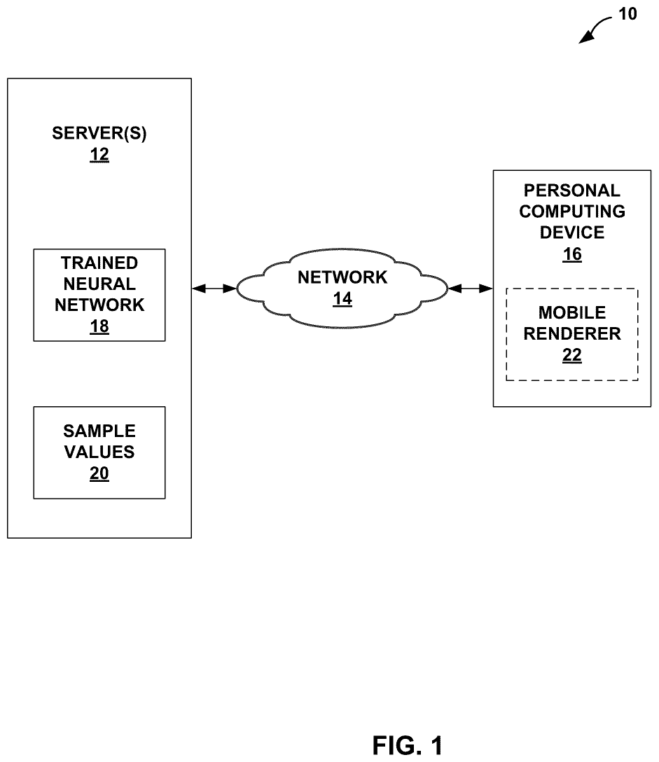

FIG. 1 is a block diagram illustrating a system 10 for creating virtual representations of users in accordance with one or more example techniques described in this disclosure. As illustrated, system 10 includes one or more servers 12, network 14, and personal computing device 16.

Examples of personal computing device 16 include mobile computing devices (e.g., tablets or smartphones), laptop or desktop computers, e-book readers, digital cameras, video gaming devices, and the like. In some examples, personal computing device 16 may be a headset such as for viewing extended reality content, such as virtual reality, augmented reality, and mixed reality. For example, a user may place personal computing device 16 close to his or her eyes, and as the user moves his or her head, the content that the user is viewing will change to reflect the direction in which the user is viewing the content.

In some examples, servers 12 are within a cloud computing environment, but the example techniques are not so limited. Cloud computing environment represents a cloud infrastructure that supports multiple servers 12 on which applications or operations requested by one or more users run. For example, the cloud computing environment provides cloud computing for using servers 12, hosted on network 14, to store, manage, and process data, rather than at personal computing device 16.

Network 14 may transport data between servers 12 and personal computing device 16. For example, network 14 may form part a packet-based network, such as a local area network, a wide-area network, or a global network such as the Internet. Network 14 may include routers, switches, base stations, or any other equipment that may be useful to facilitate data between personal computing device 16 and servers 12.

Examples of servers 12 include server devices that provide functionality to personal computing device 16. For example, servers 12 may share data or resources for performing computations for personal computing device 16. As one example, servers 12 may be computing servers, but the example techniques are not so limited. Servers 12 may be a combination of computing servers, web servers, database servers, and the like.

Content creators for three-dimensional image content may utilize implicit rendering techniques described above, and the content creators may work in various fields such as commerce, video games, etc. For ease of illustration and example purposes only, one or more examples are described in the space of commerce, but the techniques described in this disclosure should not be considered limited.

For example, a company may generate three-dimensional image content of an object (e.g., a couch) that a user can view from all angles with personal computing device 16. In one or more examples, the company may utilize machine learning (e.g., deep learning) techniques to generate photorealistic three-dimensional image content. As an example, the company may generate two-dimensional images of the object (e.g., couch) from different viewing angles and different locations of the object (e.g., in front, behind, above, below, etc.). One or more servers 12 may then use the two-dimensional images to generate train a neural network. One example way in which to train the neural network is using the NeRF training techniques; however, other techniques are possible. MipNeRF is another example. In MipNeRF, the images may be from different distances, and allow for different resolutions. The result of the training is trained neural network 18, as one example. In such machine learning based three-dimensional image content generation, trained neural network 18 is set of continuous mathematical functions and equations that define the object from any viewing angle or position. That is, rather than explicit rendering techniques in which there is a mesh or some other form of physical model that defines the object, in implicit rendering techniques, trained neural network 18 defines the object.

For instance, the way three-dimensional image content is displayed has evolved over time. Three-dimensional content was represented via point clouds, then voxels, meshes etc. Mesh is currently the de-facto representation, finding application in games, three-dimensional movies, AR/VR etc.

As described, three-dimensional content may be represented via implicit functions. The three-dimensional content is assumed to be a function, and one or more servers 12 try to learn this function with the help of various inductive biases. This is similar to learning functions in deep learning. In one or more examples, one or more server 12 approximate these functions with neural networks to generate trained neural network 18.

For a user to view the object, the user may execute an application on personal computing device 16. For instance, the user may execute mobile renderer 22. Examples of mobile renderer 22 includes a web browser, a gaming application, or an extended reality (e.g., virtual reality, augmented reality, or mixed reality) application. In some examples, mobile renderer 22 may be company specific application (e.g., an application generated by the company to allow the user to view couches made by the company). There may be other examples of mobile renderer 22, and the techniques described in this disclosure are not limited to the above examples.

In some techniques, to view the image content of the object, personal computing device 16 may download trained neural network 18 for local execution. For instance, personal computing device 16 may query trained neural network 18 (e.g., multi-layer perceptron (MLP) neural network) to generate sample values (e.g., at least one of color values and density values) for samples of the object. As an example, inputs to trained neural network 18 may be coordinates and possibly a direction, and output from trained neural network 18 may be sample values of samples of the object. For MipNeRF, the input may be a conical frustum and the output may be sample values of samples of the object.

However, querying trained neural network 18 can be time and processing extensive, and therefore, there may be delay when personal computing device 16 can render the image content of the object. In extended reality, as well as other scenarios, such as where the user is viewing the object from different directions, such rendering lag may be undesirable. That is, although utilizing trained neural network 18 may result in high-quality photorealistic image content, the rendering lag may result in user frustration.

This disclosure describes example techniques that allow personal computing device 16 to render image content generated from trained neural network 18 in real-time. That is, rendering rate may be fast enough to achieve the desired rendering rate (e.g., 30 frames per second). For instance, rather than querying trained neural network 18 on personal computing device 16, in one or more examples, personal computing device 16 may be configured to retrieve sample values that are already stored in memory of personal computing device 16.

In one or more examples, one or more servers 12 may be configured to execute trained neural network 18 on one or more servers 12. Because the processing power of one or more servers 12 may be relatively high, one or more servers 12 may be able to execute trained neural network 18 relatively quickly. The result of executing trained neural network 18 may be sample values 20 (e.g., color and/or density values). Sample values 20 may be color and density values for samples of the object from many different viewing perspectives. Sample values 20 may be considered as an implicit representation of the object since sample values 20 are generated from the continuous mathematical function and equations that define the object.

For example, sample values 20 may include color and density values for the object if the user is viewing the object from in front. Sample values 20 may also include color and density values for the object if the user is viewing the object from behind, on each side, from above, from below, and in some examples, for all practical viewing angles. That is, sample values 20 may include color and density values of the object viewed from most any of the 360°.

In one or more examples, in response to executing mobile rendered 22, personal computing device 16 may request for sample values 20. One or more servers 12 may transmit sample values 20 to personal computing device 16. Personal computing device 16 may then utilize sample values 20 to render the image content for the object. Because sample values 20 include color and density values from different directions and locations of the object, as the user moves or interacts with the rendered image content, personal computing device 16 may access the particular color and density values from sample values 20 that correspond to the direction and location at which the user is viewing the object. For instance, although possible, rather than one or more servers 12 repeatedly generating color and density values based on location and direction at which the user is viewing the image content, one or more servers 12 may generate sample values 20 that include color and density values from many different viewing locations and directions, and a full 360° view of the object may be possible from the already generated sample values 20.

Personal computing device 16, in response to execution of mobile renderer 22, may be configured to store sample values 20 in memory. As one example, personal computing device 16 may store sample values 20 as lookup tables. Accordingly, personal computing device 16 may access the color and density values in lookup tables, which may be more computationally efficient than executing trained neural network 18. In some cases, it may be possible for personal computing device to receive and execute trained neural network 18, and the example techniques should not be interpreted to mean that personal computing device 16 never receives trained neural network 18.

As described, one or more servers 12 may transmit sample values 20. In some examples, one or more servers 12 may filter sample values 20 generated from executing trained neural network 18 to a voxel grid, which may be a sparse voxel grid. A voxel grid may be considered as a three-dimensional volume, where points within the volume are voxels. Each voxel may have color and density, and the voxels together may represent the image content that is viewable from any direction.

As also described, sample values 20 may include color and density values. In some examples, in addition to color and density values, sample values 20 may also include normal vectors from the samples on the object (e.g., vectors that extend 90° from the object).

For purposes of rendering the image content of the object by personal computing device 16, not all sample values of samples of the object may needed. In some examples, one or more servers 12 may transmit sample values 20 only for the filled voxels.

There may be certain issues with NeRF and implicit representations. While NeRF and implicit representations generate photorealistic renderings of captured objects in constrained environments and synthetic data, NeRF faces several limitations while dealing with real world data, such as dealing with specular objects, varying lighting conditions, background handling among others.

That is, NeRF techniques may function extremely well under constrained environments where distance from object, lighting, etc. can be controlled, but may result in poorer quality in real-life situations. For example, when the captured images observe scene content at multiple resolutions or the camera distance from the object is changing, the rendered images in NeRF are highly blurred and contain aliasing artifacts.

In real world data capture scenario, especially when the data captured is through a hand-held device, the distance of the object is constantly varying from the camera. In commerce applications, it may be desirable to view the rendered images at different resolution or scale than those of captured images.

Another issue with NeRF's ray tracing is that the points sampled features ignore the size of the volume viewed by each ray, hence two different cameras imaging the same position at different scales may produce the same ambiguous point-sampled feature, thereby limiting the performance when the cameras are not equidistant from the object.

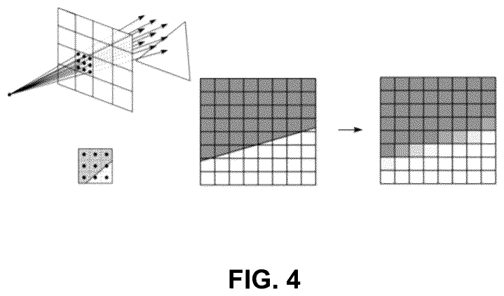

MipNeRF proposed to solve this by making use of cone tracing and integrate positional encoding (IPE). As described, aliasing has been a major problem in rendering. One screen pixel may be associated with more than just a line in space and may actually corresponds to a cone because a pixel covers an area and not a single point on screen as illustrated in FIG. 4. This is typically a source of aliasing that arises when a single ray is used per-pixel to sample the scene.

In some examples, anti-aliasing is typically done via either super-sampling or pre-filtering. Super-sampling is computationally expensive especially for NeRF, where one or more servers 12 may have to evaluate multiple points on a ray through a MLP. MipNeRF is based on pre-filtering, where instead of representing the scene using multiple copies at fixed number of scale (like in mipmap), MipNeRF learns a single neural scene model that can be queried at arbitrary scales. That is, trained neural network 18 may be queried at arbitrary scales allowing for image content at different resolutions.

MipNeRF solves this problem by casting a cone from each pixel instead of line rays. Instead of sampling points along the ray, MipNeRF divides the cone into a series of conical frustums. In MipNeRF, an IPE may be used to represent the volume covered by each conical frustum instead of points sampled on a ray. In MipNeRF, the conical frustum may be approximated with a multivariate Gaussian, which is the IPE.

In one or more examples, one or more servers 12 may be configured to sample a continuous function, such as by executing trained neural network 18, for generating sample values 20 for storing inside a grid. In examples where rays are used, one or more servers 12 may generate the sample values may sampling points along a ray to generate the color and density (e.g., opacity) values (e.g., sample values 20).

This disclosure describes examples of one or more servers 12 determining sample values 20, where the determination of sample values 20 is not based on points along the ray, but rather conical frustums. That is, for ray-based examples, determining sample values 20 may include determining color and density values along the ray by inputting coordinates along the ray into a ray-based trained neural network. However, in examples, where trained neural network 18 is based on conical frustums, sample values 20 may be generated from conical frustums of a cone instead of points along a ray.

In one or more examples, calculating sample values 20 (e.g., color and density such as opacity values) for each voxel of the object may be the first step for storing sample values 20 as a grid (e.g., look-up table). The example techniques may make it possible to render an implicit representation real time, while being able to handle inputs at different resolutions. In some examples, to calculate opacity for each voxel, the inputs may be same as while training trained neural network 18, where the inputs may be conical frustums.

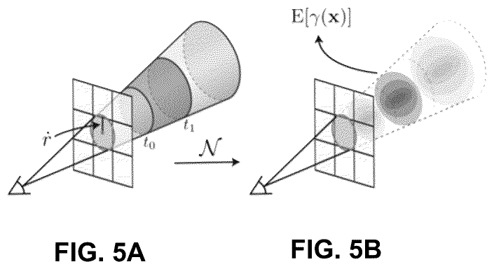

As described above, MipNeRF samples conical frustums (portion of the cone) and tries to figure out the average (formally referred as Expectation) of all the featurized points contained inside the frustum. This average is the average integral of all the positionally encoded points inside the frustum (hence the name integrated positional encoding (IPE)), given by the equation below. The variables of the below equation are illustrated in FIGS. 5A and 5B.

$${γ}^{*} ( o , d , \dot{r} , {t}_{0} , {t}_{1} ) = \frac{\int γ ( x ) F ( x , o , d , \dot{r} , {t}_{0} , {t}_{1} ) dx}{\int F ( x , o , d , \dot{r} , {t}_{0} , {t}_{1} ) dx} .$$

The conical frustums can be approximated with a multivariate Gaussian, which can give an efficient approximation of the IPE. The multivariate Gaussian can be represented by a mean vector and covariance matrix (analogous to the 1D gaussian version of mean and variance).

The mean vector (μ) is the midpoint of the ray through the conical frustum between the interval t0 and t1 (fig left below) and the covariance matrix (Σ) summarizes the covariances of all pairs of variables thereby giving a control over the gaussian lobe in different directions inside the frustum. For instance, FIG. 5A is a conceptual diagram illustrating conical frustums. FIG. 5B is a conceptual diagram illustrating lobes inside the frustums.

In one or more examples, one or more servers 12 approximate the conical frustum corresponding to voxel with a multivariate Gaussian, where one or more servers 12 formulate the covariance as an identity matrix with diagonal values as the square root of voxel width. Voxel width depends on the resolution we want to sample.

This covariance matrix ensures the Gaussian lobe (e.g., shown in FIG. 5B) matches the size of the voxel, and with this as input, one or more servers 12 may determine the opacity (e.g., density values of sample values 20) corresponding to a voxel. One or more servers 12 may calculate the per voxel opacity (e.g., density values for samples values 20) and pass on for thresholding and culling.

Accordingly, in one or more examples, one or more servers configured to determine a mean vector indicative of a ray through one or more conical frustums and a covariance matrix defining lobes in different directions inside the one or more conical frustums to generate an approximation of the one or more conical frustums, generate an input into a trained neural network based on the determined mean vector and the covariance matrix, wherein the trained neural network is trained based on two-dimensional images at different distances from an object and configured to generate sample values of samples of the object, generate the sample values for rendering the object from the trained neural network based on the input, and output the sample values. In one or more examples, the mean vector is through a midpoint of the one or more conical frustums. In one or more examples, the covariance matrix includes an identity matrix with diagonal values equal to approximately (e.g., ±10%) a square root of a voxel width. In some examples, one or more servers 12 are configured to receive information indicative of the voxel width.

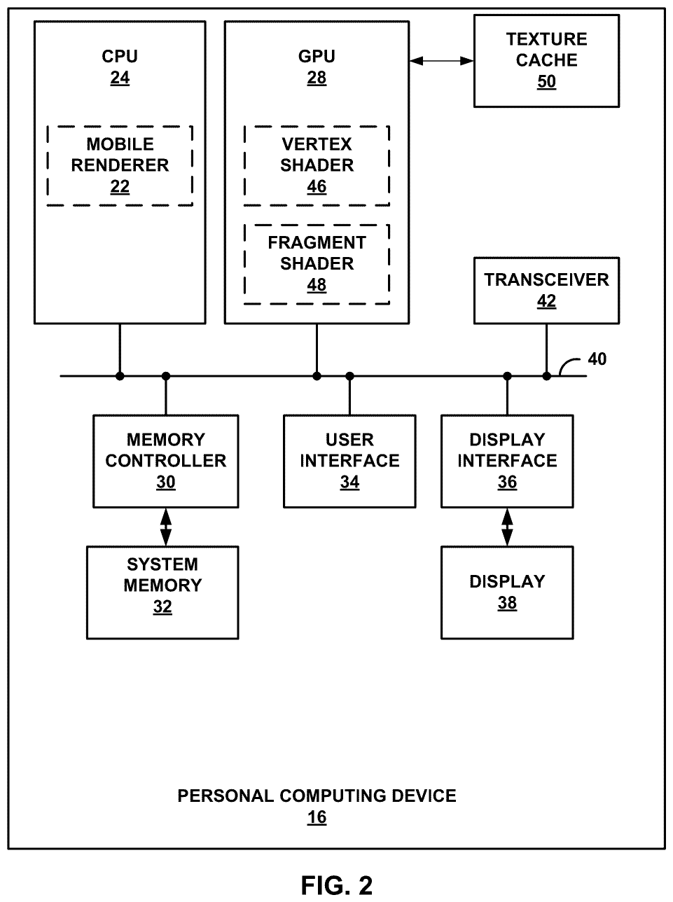

FIG. 2 is a block diagram illustrating an example of a personal computing device configured to perform real-time rendering of image content generated from implicit rendering in accordance with one or more example techniques described in this disclosure. Examples of personal computing device 16 include a computer (e.g., personal computer, a desktop computer, or a laptop computer), a mobile device such as a tablet computer, a wireless communication device (such as, e.g., a mobile telephone, a cellular telephone, a satellite telephone, and/or a mobile telephone handset), a landline telephone, an Internet telephone, a handheld device such as a portable video game device or a personal digital assistant (PDA). Additional examples of personal computing device 12 include a personal music player, a video player, a display device, a camera, a television, or any other type of device that processes and/or displays graphical data.

As illustrated in the example of FIG. 2, personal computing device 16 includes a central processing unit (CPU) 24, a graphical processing unit (GPU) 28, memory controller 30 that provides access to system memory 32, user interface 34, and display interface 36 that outputs signals that cause graphical data to be displayed on display 38. Personal computing device 16 also includes transceiver 42, which may include wired or wireless communication links, to communicate with network 14 of FIG. 1.

Also, although the various components are illustrated as separate components, in some examples the components may be combined to form a system on chip (SoC). As an example, CPU 24, GPU 28, and display interface 36 may be formed on a common integrated circuit (IC) chip. In some examples, one or more of CPU 24, GPU 28, and display interface 36 may be in separate IC chips. Various other permutations and combinations are possible, and the techniques should not be considered limited to the example illustrated in FIG. 2. The various components illustrated in FIG. 2 (whether formed on one device or different devices) may be formed as at least one of fixed-function or programmable circuitry such as in one or more microprocessors, application specific integrated circuits (ASICs), field programmable gate arrays (FPGAs), digital signal processors (DSPs), or other equivalent integrated or discrete logic circuitry.

This disclosure describes example techniques being performed by processing circuitry. Examples of the processing circuitry includes any one or combination of CPU 24, GPU 28, and display interface 36. For explanation, the disclosure describes certain operations being performed by CPU 24, GPU 28, and display interface 36. Such example operations being performed by CPU 24, GPU 28, and/or display interface 36 are described for example purposes only, and should not be considered limiting.

The various units illustrated in FIG. 2 communicate with each other using bus 40. Bus 40 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 2 is merely exemplary, and other configurations of computing devices and/or other image processing systems with the same or different components may be used to implement the techniques of this disclosure.

CPU 24 may be a general-purpose or a special-purpose processor that controls operation of personal computing device 16. A user may provide input to personal computing device 16 to cause CPU 24 to execute one or more software applications. The software applications that execute on CPU 24 may include, for example, mobile renderer 22. However, in other applications, GPU 28 or other processing circuitry may be configured to execute mobile renderer 44. A user may provide input to personal computing device 16 via one or more input devices (not shown) such as a keyboard, a mouse, a microphone, touchscreen, a touch pad or another input device that is coupled to personal computing device 16 via user interface 34. In some examples, such as where personal computing device 16 is a mobile device (e.g., smartphone or tablet), user interface 34 may be part of display 38.

GPU 28 may be configured to implement a graphics pipeline that includes programmable circuitry and fixed-function circuitry. GPU 28 is an example of processing circuitry configured to perform one or more example techniques described in this disclosure. In general, GPU 28 (e.g., which is an example processing circuitry) may be configured to perform one or more example techniques described in this disclosure via fixed-function circuits, programmable circuits, or a combination thereof. Fixed-function circuits refer to circuits that provide particular functionality and are preset on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

GPU 28 may include arithmetic logic units (ALUs), elementary function units (EFUs), digital circuits, analog circuits, and/or programmable cores, formed from programmable circuits. In examples where the operations of GPU 28 are performed using software executed by the programmable circuits, memory 32 may store the object code of the software that GPU 28 receives and executes.

Display 38 may include a monitor, a television, a projection device, a liquid crystal display (LCD), a plasma display panel, a light emitting diode (LED) array, electronic paper, a surface-conduction electron-emitted display (SED), a laser television display, a nanocrystal display or another type of display unit. Display 38 may be integrated within personal computing device 16. For instance, display 38 may be a screen of a mobile telephone handset or a tablet computer. Alternatively, display 38 may be a stand-alone device coupled to personal computing device 16 via a wired or wireless communications link. For instance, display 38 may be a computer monitor or flat panel display connected to a personal computer via a cable or wireless link.

CPU 24 and GPU 28 may store image data, and the like in respective buffers that are allocated within system memory 32. In some examples, GPU 28 may include dedicated memory, such as texture cache 50. Texture cache 50 may be embedded on GPU 28, and may be a high bandwidth low latency memory. Texture cache 50 is one example of memory of GPU 28, and there may be other examples of memory for GPU 28. For example, the memory for GPU 28 may be used to store textures, mesh definitions, framebuffers and constants in graphics mode. The memory for GPU 28 may be split into two main parts: the global linear memory and texture cache 50. Texture cache 50 may be dedicated to the storage of two-dimensional or three-dimensional textures.

A texture in graphics processing may refer to image content that rendered on to an object geometry. As described in more detail, the object geometry on which image content is rendered in one or more examples may be a two-dimensional plane geometry that functions as a proxy object geometry, but the techniques are not limited to a two-dimensional plane geometry. That is, in some techniques, a texture is placed on a three-dimensional mesh that represents the object. The three-dimensional mesh may be considered as an object geometry. In one or more examples described in this disclosure, the texture may be placed on a two-dimensional plane geometry instead of a three-dimensional object geometry.

Texture cache 50 may be spatially close to GPU 28. In some examples, texture cache is accessed through texture samplers that are special dedicated hardware providing very fast linear interpolations.

System memory 32 may also store information. In some examples, due to the limited size of texture cache 50, GPU 28 and/or CPU 26 may determine whether the desired information is stored in texture cache 50 first. If the information is not stored in texture cache 50, CPU 26 and/or GPU 28 may retrieve the information for storage in texture cache

Memory controller 30 facilitates the transfer of data going into and out of system memory 32. For example, memory controller 30 may receive memory read and write commands, and service such commands with respect to memory 32 in order to provide memory services for the components in personal computing device 16. Memory controller 30 is communicatively coupled to system memory 32. Although memory controller 30 is illustrated in the example of personal computing device 16 of FIG. 2 as being a processing circuit that is separate from both CPU 24 and system memory 32, in other examples, some or all of the functionality of memory controller 30 may be implemented on one or both of CPU 24 and system memory 32.

System memory 32 may store program modules and/or instructions and/or data that are accessible by CPU 24 and GPU 28. For example, system memory 32 may store user applications (e.g., object code for mobile renderer 44), rendered image content from GPU 28, etc. System memory 32 may additionally store information for use by and/or generated by other components of personal computing device 16. System memory 32 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

In some aspects, system memory 32 may include instructions that cause CPU 24, GPU 28, and display interface 36 to perform the functions ascribed to these components in this disclosure. Accordingly, system memory 32 may be a computer-readable storage medium having instructions stored thereon that, when executed, cause one or more processors (e.g., CPU 24, GPU 28, and display interface 36) to perform various functions.

In some examples, system memory 32 is a non-transitory storage medium. The term “non-transitory” indicates that the storage medium is not embodied in a carrier wave or a propagated signal. However, the term “non-transitory” should not be interpreted to mean that system memory 32 is non-movable or that its contents are static. As one example, system memory 32 may be removed from personal computing device 16, and moved to another device. As another example, memory, substantially similar to system memory 32, may be inserted into personal computing device 16. In certain examples, a non-transitory storage medium may store data that can, over time, change (e.g., in RAM).

Display interface 36 may retrieve the data from system memory 32 and configure display 38 to display the image represented by the generated image data. In some examples, display interface 36 may include a digital-to-analog converter (DAC) that is configured to convert the digital values retrieved from system memory 32 into an analog signal consumable by display 38. In other examples, display interface 36 may pass the digital values directly to display 38 for processing.

One or more servers 12 may transmit sample values 20 and, in some examples, as a grid. Transceiver 42 may receive the information, and a decoder (not shown) may reconstruct sample values 20. In one or more examples, texture cache 50 may store some or all of sample values 20.

In accordance with one or more examples, CPU 24 and GPU 28 may together utilize sample values 20 to render the image content of the object for display on display 38. For instance, as illustrated and described above, CPU 24 may execute mobile renderer 22, which may be the application for which the image content of the object is being rendered. GPU 28 may be configured to execute vertex shader 46 and fragment shader 48 to actually render the image content of the object. As mobile renderer 22 is executing on CPU 24, mobile renderer 22 may cause CPU 24 to instruct GPU 28 to execute vertex shader 46 and fragment shader 48, as needed. Mobile renderer 22 may generate instructions or data that are fed to vertex shader 46 and fragment shader 48 for rendering. Vertex shader 46 and fragment shader 48 may execute on the programmable circuitry of GPU 28, and other operations of the graphics pipeline may be performed on the fixed-function circuitry of GPU 28.

Vertex shader 46 may be configured to transform data from a world coordinate system of the user given by an operating system or mobile renderer 22 into a special coordinate system known as clip space. For instance, the user may be located at a particular location, and the location of the user may be defined in world coordinate system. However, where the image content is to be rendered so that the image content is rendered at the correct perspective, such as size and location, may be based on clip space.

Vertex shader 46 may be configured to determine a ray origin, a direction, and near and far values for hypothetical rays in a three-dimensional space that is defined by the voxel grid. Fragment shader 48 may access texture cache 50 to determine the color and density values along the hypothetical rays in the three-dimensional space.

For example, to store sample values 20, CPU 24, or possibly GPU 28, may store color and density values in texture cache 50 as a lookup table. Along a hypothetical ray, there may be a plurality of points. Each point may correspond to a particular coordinate.

It should be noted that vertex shader 46 and fragment shader 48 utilizing rays and determining color and density values along the rays is part of volumetric rendering. However, sample values 20, stored in texture cache 50 and generated from trained neural network 18, may have been generated using conical frustums, and not rays. That is, sample values may be generated from conical frustums as inputs into trained neural network 18, and the result of that may be sample values 20. GPU 28 may then render the image content of the object using sample values 20. To render the image content, GPU 28 may use volumetric rendering, in which GPU 28 may utilize rays to determine where rays intersect sample values 20.

For example, fragment shader 48 may input coordinates for a first point on a ray, and determine the color and density values for the first point. Fragment shader 48 may access a determined location in the lookup table to determine the color and density values for the first point. Fragment shader 48 may input coordinates for a second point on the ray, and determine the color and density values for the second point. Fragment shader 48 may access a determined location in the lookup table to determine the color and density values for the second point. Fragment shader 48 may repeat such operations for points along the ray.

Fragment shader 48 may determine values for pixels in two-dimensional space based on the sample values (e.g., color and density values) along the hypothetical rays in the three-dimensional space. As one example, fragment shader 48 may integrate the color and density values along the ray in the three-dimensional space to determine a value for a pixel in two-dimensional space. There may be other ways in which fragment shader 48 may determine the color and density value for a pixel in two-dimensional space.

Fragment shader 48 may render the determined values for the pixels. In this way, texture cache 50 may store sample values 20 that were generated using implicit rendering techniques including using conical frustums, and tend to be fairly photorealistic and use these already stored sample values to render pixels for display on display 38. Rather than requiring personal computing device 16 to execute trained neural network 18, GPU 28 may be able to utilize sample values 20 generated using trained neural network 18 to perform photorealistic rendering because texture cache 50 may already store samples values 20, where sample values 20 were generated using trained neural network 18.

In some examples, mobile renderer 22 may be configured to output the commands to vertex shader 46 and/or fragment shader 48. The commands may conform to a graphics application programming interface (API), such as, e.g., an Open Graphics Library (OpenGL®) API, OpenGL® 3.3, an Open Graphics Library Embedded Systems (OpenGL ES) API, an OpenCL API, a Direct 3D API, an X3D API, a RenderMan API, a WebGL API, or any other public or proprietary standard graphics API. The techniques should not be considered limited to requiring a particular API.

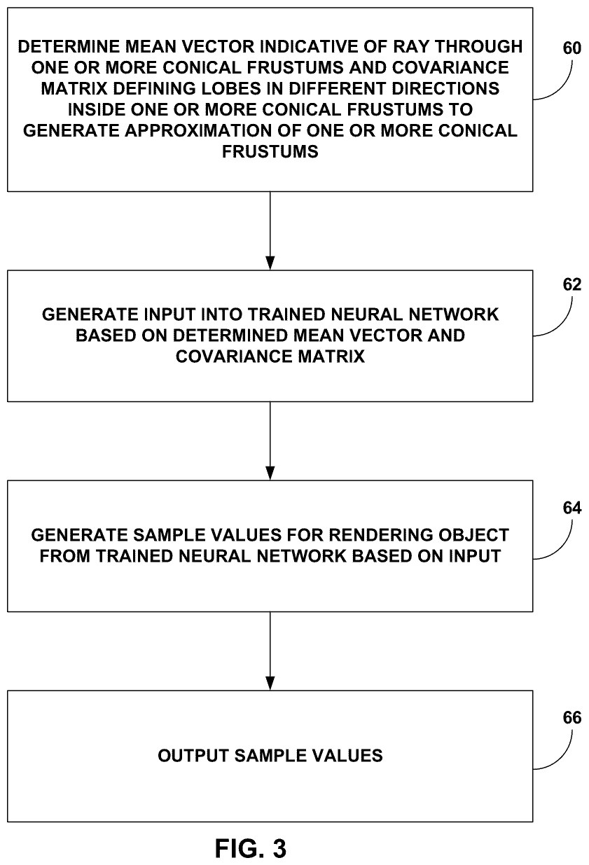

FIG. 3 is a flowchart illustrating an example of real-time rendering of image content generated from implicit rendering. The example techniques are described as being performed by one or more servers 12.

One or more servers 12 may determine a mean vector indicative of a ray through one or more conical frustums and a covariance matrix defining lobes in different directions inside the one or more conical frustums to generate an approximation of the one or more conical frustums (60). One or more servers 12 may generate an input into a trained neural network based on the determined mean vector and the covariance matrix (62). The trained neural network is trained based on two-dimensional images at different distances from an object and configured to generate sample values of samples of the object.

One or more servers 12 may generate the sample values for rendering the object from the trained neural network based on the input (64), and output the sample values (66). In one or more examples, the mean vector is through a midpoint of the one or more conical frustums. In one or more examples, the covariance matrix is an identity matrix with diagonal values equal to approximately a square root of a voxel width. In one or more examples, one or more servers 12 may receive information indicative of the voxel width.

The various following examples may be performed together or separately.

Example 1. A system for graphical rendering, the system comprising: one or more servers configured to: determine a mean vector indicative of a ray through one or more conical frustums and a covariance matrix defining lobes in different directions inside the one or more conical frustums to generate an approximation of the one or more conical frustums; generate an input into a trained neural network based on the determined mean vector and the covariance matrix, wherein the trained neural network is trained based on two-dimensional images at different distances from an object and configured to generate sample values of samples of the object; generate the sample values for rendering the object from the trained neural network based on the input; and output the sample values.

Example 2. The system of example 1, wherein the mean vector is through a midpoint of the one or more conical frustums.

Example 3. The system of any of examples 1 and 2, wherein the covariance matrix comprises an identity matrix with diagonal values equal to approximately a square root of a voxel width.

Example 4. The system of example 3, wherein the one or more servers are configured to receive information indicative of the voxel width.

Example 5. The system of any of examples 1-4, wherein to determine the covariance matrix, the one or more servers are configured to determine the covariance matrix that defines lobes that match size of a voxel of the object.

Example 6. The system of any of examples 1-5, wherein to generate the sample values, the one or more servers are configured to generate per voxel opacity for the sample values.

Example 7. The system of any of examples 1-6, wherein to generate the sample values, the one or more servers are configured to generate the sample value for rendering the object from the trained neural network based on the input by sampling a continuous function.

Example 8. The system of any of examples 1-7, wherein the trained neural network comprises a trained neural network based on multum in parvo neural radiance field (MipNeRF).

Example 9. A method for graphical rendering, the method comprising: determining a mean vector indicative of a ray through one or more conical frustums and a covariance matrix defining lobes in different directions inside the one or more conical frustums to generate an approximation of the one or more conical frustums; generating an input into a trained neural network based on the determined mean vector and the covariance matrix, wherein the trained neural network is trained based on two-dimensional images at different distances from an object and configured to generate sample values of samples of the object; generating the sample values for rendering the object from the trained neural network based on the input; and outputting the sample values.

Example 10. The method of example 9, wherein the mean vector is through a midpoint of the one or more conical frustums.

Example 11. The method of any of examples 9 and 10, wherein the covariance matrix comprises an identity matrix with diagonal values equal to approximately a square root of a voxel width.

Example 12. The method of example 11, further comprising receiving information indicative of the voxel width.

Example 13. The method of any of examples 9-12, wherein determining the covariance matrix comprises determining the covariance matrix that defines lobes that match size of a voxel of the object.

Example 14. The method of any of examples 9-13, wherein generating the sample values comprises generating per voxel opacity for the sample values.

Example 15. The method of any of examples 9-14, wherein generating the sample values comprises generating the sample value for rendering the object from the trained neural network based on the input by sampling a continuous function.

Example 16. The method of any of examples 9-15, wherein the trained neural network comprises a trained neural network based on multum in parvo neural radiance field (MipNeRF).

Example 17. A computer-readable storage medium storing instructions thereon that when executed cause one or more servers to: determine a mean vector indicative of a ray through one or more conical frustums and a covariance matrix defining lobes in different directions inside the one or more conical frustums to generate an approximation of the one or more conical frustums; generate an input into a trained neural network based on the determined mean vector and the covariance matrix, wherein the trained neural network is trained based on two-dimensional images at different distances from an object and configured to generate sample values of samples of the object; generate the sample values for rendering the object from the trained neural network based on the input; and output the sample values.

Example 18. The computer-readable storage medium of example 17, wherein the mean vector is through a midpoint of the one or more conical frustums.

Example 19. The computer-readable storage medium of any of examples 17 and 18, wherein the covariance matrix comprises an identity matrix with diagonal values equal to approximately a square root of a voxel width.

Example 20. The computer-readable storage medium of example 19, wherein instructions further comprise instructions that when executed cause the one or more servers to receive information indicative of the voxel width.

The techniques of this disclosure may be implemented in a wide variety of computing devices. Any of the described units, modules or components may be implemented together or separately as discrete but interoperable logic devices. Depiction of different features as applications or units is intended to highlight different functional aspects and does not necessarily imply that such applications or units must be realized by separate hardware or software components. Rather, functionality associated with one or more applications or units may be performed by separate hardware or software components, or integrated within common or separate hardware or software components.

The techniques described in this disclosure may be implemented, at least in part, in hardware, software, firmware or any combination thereof. For example, various aspects of the techniques may be implemented within one or more microprocessors, digital signal processors (DSPs), application specific integrated circuits (ASICs), field programmable gate arrays (FPGAs), or any other equivalent integrated or discrete logic circuitry. The terms “processor,” “processing circuitry,” “controller” or “control module” may generally refer to any of the foregoing logic circuitry, alone or in combination with other logic circuitry, or any other equivalent circuitry, and alone or in combination with other digital or analog circuitry.

For aspects implemented in software, at least some of the functionality ascribed to the systems and devices described in this disclosure may be embodied as instructions on a computer-readable storage medium such as random access memory (RAM), read-only memory (ROM), non-volatile random access memory (NVRAM), electrically erasable programmable read-only memory (EEPROM), FLASH memory, magnetic media, optical media, or the like that is tangible. The computer-readable storage media may be referred to as non-transitory. A server, client computing device, or any other computing device may also contain a more portable removable memory type to enable easy data transfer or offline data analysis. The instructions may be executed to support one or more aspects of the functionality described in this disclosure.

In some examples, a computer-readable storage medium comprises non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the devices, systems, and methods in accordance with the description provided in this disclosure are provided below.

What is claimed is:

1. A system for graphical rendering, the system comprising:
one or more servers configured to:
determine a mean vector indicative of a ray through one or more conical frustums and a covariance matrix defining lobes in different directions inside the one or more conical frustums to generate an approximation of the one or more conical frustums;
generate an input into a trained neural network based on the determined mean vector and the covariance matrix, wherein the trained neural network is trained based on two-dimensional images at different distances from an object and configured to generate sample values of samples of the object;
generate the sample values for rendering the object from the trained neural network based on the input; and
output the sample values.

2. The system of claim 1, wherein the mean vector is through a midpoint of the one or more conical frustums.

3. The system of claim 1, wherein the covariance matrix comprises an identity matrix with diagonal values equal to approximately a square root of a voxel width.

4. The system of claim 3, wherein the one or more servers are configured to receive information indicative of the voxel width.

5. The system of claim 1, wherein to determine the covariance matrix, the one or more servers are configured to determine the covariance matrix that defines lobes that match size of a voxel of the object.

6. The system of claim 1, wherein to generate the sample values, the one or more servers are configured to generate per voxel opacity for the sample values.

7. The system of claim 1, wherein to generate the sample values, the one or more servers are configured to generate the sample value for rendering the object from the trained neural network based on the input by sampling a continuous function.

8. The system of claim 1, wherein the trained neural network comprises a trained neural network based on multum in parvo neural radiance field (MipNeRF).

9. A method for graphical rendering, the method comprising:
determining a mean vector indicative of a ray through one or more conical frustums and a covariance matrix defining lobes in different directions inside the one or more conical frustums to generate an approximation of the one or more conical frustums;
generating an input into a trained neural network based on the determined mean vector and the covariance matrix, wherein the trained neural network is trained based on two-dimensional images at different distances from an object and configured to generate sample values of samples of the object;
generating the sample values for rendering the object from the trained neural network based on the input; and
outputting the sample values.

10. The method of claim 9, wherein the mean vector is through a midpoint of the one or more conical frustums.

11. The method of claim 9, wherein the covariance matrix comprises an identity matrix with diagonal values equal to approximately a square root of a voxel width.

12. The method of claim 11, further comprising receiving information indicative of the voxel width.

13. The method of claim 9, wherein determining the covariance matrix comprises determining the covariance matrix that defines lobes that match size of a voxel of the object.

14. The method of claim 9, wherein generating the sample values comprises generating per voxel opacity for the sample values.

15. The method of claim 9, wherein generating the sample values comprises generating the sample value for rendering the object from the trained neural network based on the input by sampling a continuous function.

16. The method of claim 9, wherein the trained neural network comprises a trained neural network based on multum in parvo neural radiance field (MipNeRF).

17. A computer-readable storage medium storing instructions thereon that when executed cause one or more servers to:
determine a mean vector indicative of a ray through one or more conical frustums and a covariance matrix defining lobes in different directions inside the one or more conical frustums to generate an approximation of the one or more conical frustums;
generate an input into a trained neural network based on the determined mean vector and the covariance matrix, wherein the trained neural network is trained based on two-dimensional images at different distances from an object and configured to generate sample values of samples of the object;
generate the sample values for rendering the object from the trained neural network based on the input; and
output the sample values.

18. The computer-readable storage medium of claim 17, wherein the mean vector is through a midpoint of the one or more conical frustums.

19. The computer-readable storage medium of claim 17, wherein the covariance matrix comprises an identity matrix with diagonal values equal to approximately a square root of a voxel width.

20. The computer-readable storage medium of claim 19, wherein instructions further comprise instructions that when executed cause the one or more servers to receive information indicative of the voxel width.
